(19) United States
(12) Patent Application Publication
(10) Pub. No.: US 2021/0269174 A1
(43) Pub. Date: Sep. 2, 2021

(54) DRONE DOCKING PORT AND METHOD OF USE

(71) Applicant: Greg Douglas Shuff, Henderson, NV (US)

(72) Inventor: Greg Douglas Shuff, Henderson, NV (US)

(21) Appl. No.: 16/802,585

(22) Filed: Feb. 27, 2020

(51) Int. Cl. B64F 1/36; B64F 1/00; B64C 39/02; B64D 47/08; B64D 27/24; B64D 47/04; B64C 25/06; B60L 50/60; B60L 53/10; B60L 53/35; B60L 53/53; B60L 53/51; G08G 5/00

(52) U.S. Cl. CPC B64F 1/362; B60L 2200/10; B64C 39/024; B64D 47/08; B64D 27/24; B64D 47/04; B64C 25/06; B60L 50/60; B60L 53/10; B60L 53/35; B60L 53/53; B60L 53/51; G08G 5/0026; B64C 2201/027; B64C 2201/042; B64C 2201/127; B64C 2201/141; B64D 2203/00; B64F 1/005

(57) ABSTRACT

A drone docking port (DDP) preferably mounted on a pole and having an openable and closable convertible top (CT), a docking plate having integrated battery wired or wireless recharging pads, and a control module. The control module (CM) is adapted to preferably autonomously control all functions of the DDP including actuation of the CT and relay of video, audio, and flight control information between the CM and a central monitoring center and/or emergency personnel. The DDP is preferable positioned in close proximity to an intended monitoring site. When the CT is in an open position, a drone may initiate flight from the DDP and when a drone flight is completed and a drone has re-docked therein, the CT may be closed to protect the drone docked therein from external weather. The DDP may further include Electro-Optical/Infra-Red (EO/IR) cameras and sensors to detect disruptive or other predetermined behavior.

### FIELD OF THE INVENTION

The present invention relates to docking for the facilitation of takeoff, landing and housing of drones or unmanned aerial vehicle (UAV), and more especially for drones or UAVs used in traffic control and border security and the like applications and in acquiring, storing and transmitting information regarding the same.

### BACKGROUND OF THE INVENTION

Many accidents occur in the US. The Insurance Information Institute reports total accidents in the U.S. for 2017 at 6,452,000 resulting in approximately 1,889,000 injuries, 34,247 deaths and $4,530,000 in property damage. The cost to respond by police, fire departments and cleanup crews to these accidents is substantial, as is the cost in terms of time and fuel consumed by drivers delayed by these accidents. Moreover, time is typically of the essence in such scenarios. Present methods of deploying drones or UAVs for specific operations, such as to observe traffic incidents or security breaches generally require drones to be physically transported to locations of interest, set up, and launched and controlled by operators with appropriate expertise. This process takes considerable time and effort and can result in missing the window of opportunity to successfully capture the incident or data of interest. Thus, there is a need for timely/efficient approach to the launch, operation and housing of monitoring drones.

### BRIEF SUMMARY OF THE INVENTION

The present invention is a drone docking port (DDP) preferably sized so as to be large enough to house (enclose) a drone but small enough to be mounted on a pole—a fence pole, a street light pole, a roadway sign pole, a traffic light pole, a bridge pillar, etc.—and having an openable and closable convertible top (CT), a docking plate having integrated battery wireless recharging pads, and a control module. The control module (CM) is adapted to preferably autonomously control all functions of the DDP including actuation of the CT and relay of video, audio, and flight control information between the CM and a central monitoring center and/or emergency personnel. The DDP is preferable positioned in close proximity to an intended monitoring site—e.g. so as to facilitate the rapid launch of a drone to monitor an incident, to provide light on or act as a beacon at the intended site, to relay information about the monitored site, to emit audible sounds at the site (e.g. warnings or instructions), and for the rapid recovery and docking of the same. When the DDP CT is in an open position, a drone may initiate flight from the DDP and when a drone flight is completed and a drone has re-docked therein, the CT may be closed so as to protect the drone docked therein from external weather. The DDP may further include EO/IR (Electro-Optical/Infra-Red) cameras and sensors so as to detect disruptive or other predetermined behavior.

More specifically, various embodiments of the DDP are contemplated. In a first embodiment, the DDP includes an enclosure base having a CT that is openable and closeable by means of a motor mechanism, a docking plate, drone battery recharging pads and/or wireless recharging pad, a control module (CM), and a battery pack. Optional DDP equipment may include solar panels, an air conditioning unit and an anemometer and related weather station equipment. In an inactive state, the CT remains in the closed or UP position and preferably fully contains a drone. In response to receipt of a signal from remote sensors or local—e.g. located on the DDP and/or in the nearby vicinity of the DDP and a potential incident—the DDP activates, thereby opening to expose the drone and allows for drone take-off and manual or autonomous flight directly to and hover above the incident (preferably with FAA (Federal Aviation Administration) authorization).

The DDP preferably includes an enclosure base which takes the form of a lower outer covering of the DDP. The enclosure base is preferably spherical, elliptical, cubic or modified spherical, elliptical or cubic in shape. The DDP enclosure base contains all devices and equipment necessary for manual or autonomous drone deployment and drone battery recharging, and to protect the drone from the outside environment while stored (in the inactive state). Furthermore, the DDP enclosure base is preferably attached to the top of a pole where it may remain for the service life of the DDP.

Preferably, the CT comprises a plurality of CT segments. Each CT segment preferably defines a portion of the overall outer surface of the DDP whether it is spherical, elliptical or cubic in shape. Each CT segment preferably has two edges and tappers to two ends which may function as fastening points. A first CT segment edge defines a Leading Edge (CTSLE) and has a substantially 90 degree protrusion extending in two directions to form a “T” shape. A second CT segment edge defines a trailing edge (CTSTE) and has a 90 degree protrusion extending away from the center of the enclosure to form an “L” Shape. The CTSLE contains a weather strip affixed thereto such that when the CTSLE of a first CT segment and a CTSTE of an adjacent T segment are adjoined, the weather strip is positioned therebetween and provides a sealed, weatherproof barrier between the CT segments. In operation, three or four CT segments may be employed to enclose the top half of the DDP when closed. When open, preferably all CT segments would be collapsed to one side of the DDP enclosure base and under the DP or surface on which a drone is docked. Opening and closing of the CT is effected by a CT motor. As the CT moves from an open to a closed position, the CT motor will rotate a first CT segment, and as the first CT segment rotates, the first CT segment CTSTE protrusion encounters a second CT segment CTSLE protrusion and drags or rotates it into a further closed position. As the CT continues to rotate, the second CT segment CTSTE protrusion will encounter a third CT segment CTSLE protrusion and drag or rotate the third CT segment into a further or completely closed position, depending on the number of segments required to completely close the CT. Once completely closed, the CT motor will shut off and the DDP enclosure will be resistant to the outside environment. To open, the reverse process occurs and the CT fully opens very rapidly—preferably within a matter of seconds.

The DDP preferably includes a docking plate that comprises of a metal, plastic or fiberglass plate that is formed to fit to the drone landing gear in such a manner as to allow the landing drone to easily land and slide into place upon initial contact with the docking plate. The docking plate preferably includes drone recharging pads or a wireless recharging pad adapted such that when a drone is in the docked or nested position, the recharging pads will make contact with recharging contacts located on the drone or the wireless recharging pad will be in close proximity to the drone's wireless recharging pad. This may potentially require drone manufactures to modify their designs to incorporate recharging contacts and/or wireless recharging contacts on the bottom portion or landing gear of their drones so that they may make contact with the recharging pads on the docking plate. Drone manufactures developing new models or designs of drones may be able to incorporate recharging contacts and/or wireless recharging contacts in their new drone designs, particularly those drone that incorporate autonomous flight.

The DDP preferably includes a control module (CM) that controls all aspects of the DDP including CT opening and closing, drone battery recharging and communications with other traffic sensor systems, central monitoring stations, first responder personnel and the relay communications to the drone in flight and/or with other drones in flight in the near vicinity. The CM may relay video signals to a central monitoring center and may provide for video recording at or in close proximity to the CM. The CM may also relay flight or camera control signals and audio commands from a central monitoring center to a drone in flight enabling central monitoring center personnel to override autonomous drone flight control should they desire. For example, the CM may receive a traffic alert from a Traffic Flow Sensor System (TFSS) of a nearby traffic accident. The TF SS is a separate device and consists of Electro-Opticatinfra-Red (EO/TR) video, stereo pair video, lidar and/or radar sensors and any combination thereof and detects and monitors traffic flow and abnormal traffic flow to include traffic incidences. Upon the TFSS issuing a traffic alert or accident indication and preferably upon approval by a central monitoring center and the FAA, the CM initiates a signal to the DDP to open the convertible top (CT) and to initiate (preferably autonomous) flight of a drone housed therein so as to enable flight and hovering of the drone over the accident, to take photographs and videos of the scene, to assist in accident scene forensics and to assist police in clearing the scene more rapidly so as to resume normal traffic flow. Central monitoring center personnel are provided the ability to override the (preferably autonomous) drone on demand so as to aid in the resolution and clearing of a traffic incidence. Designated emergency personnel with first-hand knowledge of the incident may also have the ability to override the (preferably autonomous) drone on demand so as to aid in the resolution and clearing of traffic incidence through their portable communications devices or cell phone apps at the incident scene. Communication with the DDP and drone may be made through the use of Bluetooth communication, LoRa

Communication, internet communication, cell phone network communication (4G/5G), independent intranet network communication, RF communication, wired communication, and optic fiber communication. Data, video, audio and remote control commands are preferably communicated or streamed in real time with very low latency in both directions—to and from the deployed drone, DDP and central monitoring center. In the event of a malfunction, a malfunction signal or code is sent to the central traffic control monitoring center for resolution.

The DDP preferably includes a Battery Pack installed in the DDP enclosure base or within a support pole upon which the DDP is mounted, providing backup electrical power to all components on the DDP, preferably for a period of 36 hours, in the event of an electrical power disruption and/or solar panel malfunction or cloud coverage. The CM monitors electrical power, solar panels and battery pack status and in the event of electrical power disruption, preferably immediately switches power from the main source to the battery pack and resumes normal operations preferably for a period up to 36 hours and will operate on battery power during at least one CT opening and closing and preferably during continuous drone battery recharging for at least 2 hours. In the event of a malfunction, the CM will forward a malfunctioning code to the central monitoring center for resolution and the battery pack would be recharged from local grid electric power or from solar panels in order to resume normal operations.

The DDP preferably includes a microphone and is enabled to detect useful information (e.g. traffic horns, wheel sketching, vehicle collisions, etc.) and relay such information to a central traffic control monitoring center for resolution.

Preferably, if the DDP malfunctions, the CM switches the DDP to work in the inactive mode, and transmits a malfunction code to a central monitoring center for resolution.

The DDP preferably further includes a support structure such as a pole upon which the DDP is mounted. The electrical power wiring and any other wiring from sensors, battery pack or the like are preferably enclosed within the support pole.

Preferably, the DDP and autonomous drone are in an inactive mode more than they are in an active mode. In the event of a (preferably nearby) incident or accident as detected by local or remote sensors, the (preferably autonomous) drone will be deployed. Once deployed, the drone will preferably immediately fly to the incident, hover over the incident, take photographs and video of the incident and surrounding scene, audibly communicate with accident victims or emergency personnel, communicate with central traffic control monitoring center operators and/or designated emergency personnel at the scene, and may perform other tasks while at or near the scene, prior to returning the DDP. Tasks, as embodied in various modes, that may be performed by the DDP in cooperation with a drone housed therein include the following:
a. Mode 1—As a closest drone to an incident, preferably autonomously fly the drone to the accident scene, take video and audio of injured, attempt to help and comfort injured through an audio transmission, transmit video and audio to a central monitoring and control station operator to enable the operator's viewing of the video and listening to the audio so as to asses—injury and damage severity. Help direct personnel and resources once on the scene, and video record injury and vehicle damage.
b. Mode 2—Once mode 1 is complete, mode 2 may be started. In mode 2, fly a drone at an appropriate height to capture video of the overall incident scene to include skid marks, etc. so as to help determine the accident cause.
c. Mode 3—Once modes 1 and 2 are complete, mode 3 may be started. In mode 3, hover the drone high enough over the scene to not interfere with personnel and in a position to provide overhead lighting during operations at night.
d. Mode 4—Once modes 1, 2 and 3 are complete, mode 4 may be started. In mode 4, fly a drone high so as to function as a beacon for police, emergency personnel and vehicle drivers and passengers, so as to provide an indication of accident location and potential traffic delays.
e. Mode 5—In mode 5, upon drone low battery indication, fly a drone back to the DDP and preferably autonomously land and recharge the drone batteries.
f. Mode 6—Enable the support of drones from nearby DDPs to provide function as an emergency traffic signal and to enable the stopping of traffic and guiding of traffic around an incident. To accomplish this function, drone swarms comprising two or more drones may coordinate traffic signaling. For example, a freeway incident covering several lanes of traffic may require 4 to 6 drones positioned over each lane and high enough above and at a distance for vehicles traveling toward the incident to be directed by signal lights on the drone so as to provide an indication to the traffic to stop, proceed with caution and proceed in specific lanes so as to allow alternate lanes of travel and consistent travel times for all vehicles to skirt the incident. The disclosed drones include cameras having solid state memory recording cards or modules which can be reviewed at a later date so as to possibly determine drone traffic signal violations or accident fault.
g. Mode 7—Enable the support of drones from DDPs that are in close proximity to incidents or drones that are carried and deployed from police vehicles and/or emergency vehicles so as to observe “rubber neck” drivers at an incident scene. Such drones would be positioned in a stationary (hovering) position high enough so as not to interfere with personnel or clean up procedures and yet in close enough proximity to the incident to observe “rubber neck” drivers with the objective of reducing the time drivers look at the incident and to increasing the attention paid to driving efficiently and safely around the incident so as to possibly significantly reduce vehicle wait times around an accident site. Enable video recordings to be reviewed at a later date so as to possibly determine “Rubber Necking” violations.
h. Mode 8—Enable the support of drones from DDPs or from Police, Fire or Emergency vehicles to function as a signal light control at an intersection so as to assist or replace police controlling traffic flow from the center of an intersection, particularly at the end of events such as sporting events, concerts, etc.
i. Mode 9—Enable the support of drones from DDPs in close proximity to accident or police vehicles and/or emergency vehicles to be controlled autonomously by control monitoring station personnel or more preferably by police at the scene. Enable the support of drones to target, track and follow a specific vehicle or person, preferably at sufficient height so as to act as a beacon and so as to provide ground personnel an indication of the tracked vehicle or person location. Enable the support of audio communications such as for police commands.

The DDP preferably includes optional solar panels in case electrical power through the grid is not available. Such solar panels are adapted to capture the Sun's rays so as to provide electrical power for all devices mounted within the DDP including the CM, the CT Motor, the DDP battery and drone battery, thus creating a completely self-sufficient system.

The DDP preferably includes an optional air conditioning and heating unit that maintains a stable temperature and humidity environment within the DDP when the CT is in the closed or UP position. In such case a cooling coil is affixed to the outside of the DDP or on the DDP support pole. As temperature outside the DDP and solar load increases, the air conditioning system is activated and reduces the DDP inner temperature and humidity. As the temperature outside the DDP decreases, the heater is activated and increases the temperature inside the DDP. By such heating and cooling, the DDP interior temperature and humidity are stabilized within an acceptable range so that the batteries within the DDP and drone can be maintained at an optimum temperature to maximize battery performance.

The DDP CT may preferably be adjusted by slightly opening the CT so that the internal space of the DDP comes into temperature equilibrium with the DDP external space temperature. Under certain conditions, as the temperature outside the DDP and solar load increases, slightly opening the CT such that there is a small opening toward the side of the DDP results in a sufficient reduction in temperature so as not to need to use the air conditioning system and to minimize internal moisture from precipitation. The ability to open the CT in this fashion is an advantage of the CT type top.

The DDP preferably includes an optional weather station, environmental sensors and anemometer so as to detect weather conditions including temperature, humidity, wind speed, rain, snow, ice, fog, dust and high winds. Upon detection of a weather condition that would be hazardous to drone flight, particularly a high wind condition, the CM prevents opening of the CT and deployment of the drone, and sends an adverse weather signal or code to the central monitoring center for further resolution.

In a first alternate embodiment, the DDP docking plate comprises a plurality of landing cones with holes at the bottom of the landing cones, sized so as to allow drone landing gear or legs to enter the holes and be captured by a capture or latch mechanism located either on the underside of the docking plate or drone landing gear. Drone landing gear recharging feet are located at the bottom of the landing gear and comprise a metal ring or washer with a hole in the center thereof that allows for the addition of an optional docking camera. A secondary plate or support plate is located below the docking plate having recharging pads affixed to the support plate and located underneath the landing cone holes so that upon drone docking, the drone's landing gear recharging feet make electrical contact and are supported by the recharging pad so that the drone's batteries will be recharged while the drone is docked within the DDP. The CM controls all aspects of DDP to include opening and closing of the CT, activating the landing gear latch, and recharging the DDP and drone batteries. In an inactive mode, the DDP contains the drone with the CT in the UP or Closed position and enclosing the drone from the outside environment, while preferably continuously monitoring and charging the drone batteries. In an active mode, the CT opens exposing the drone, the drone's motors start and the capture or latch mechanism activates to allow drone takeoff. Once drone takeoff is complete, the latch mechanism deactivates and awaits drone return. Upon drone return, the drone preferably autonomously positions itself above the DDP for landing, verifies proper orientation with distinguishing rings painted on the cones, then descends to the docking plate where the drones landing gear recharging feet make contact with the plurality of landing cones and in-turn the landing cones guide the drone landing gear recharging feet into the landing gear holes at the bottom, where the landing gear recharging feet and legs drop into the holes with the recharging feet making contact with the recharging pad and the landing gear legs being latched by the latch mechanism located either on the underside of the docking plate or within the drone landing gear. Once secure, the CT closes to cover the drone and enclose it from the outside environment and reverts to the inactive mode where the drone is docked until the next drone activation after drone batteries are recharged.

In a second alternate embodiment, a spring-loaded latch mechanism is located below the docking plate and adapted such that when inactive will be in a position to capture drone landing gear. As the landing gear recharging feet and legs enter the capture and retention hole, the spring-loaded latch mechanism is pushed in and compresses the spring. Once the landing gear recharging feet touch down on the recharging pad, the landing gear latch catch area is fully exposed and the compressed spring-loaded latch mechanism clicks into place, capturing and retaining the landing gear leg. Once two or more landing gear legs are captured and retained, the drone is captured and retained upon the DDP. When the landing gear legs are captured and retained, the CT closes and the drone batteries are recharged. When activated, the CT will Open, the drone propellers will start and a latch mechanism solenoid will be electrically activated, pulling the spring-loaded latch mechanism away from the landing gear legs and releasing the landing gear legs from the latch mechanism and allowing take-off of the drone. After take-off, the spring-loaded latch mechanism reverts to its inactive catch position and is ready to catch the drone landing gear legs upon return. The only time the latch mechanism solenoid is activated is during drone takeoff.

In a third alternate embodiment, an alternately configured drone landing gear leg or drone landing gear leg add-on is included that provides a spring-loaded drone latch mechanism located on the lower part of the landing gear leg toward the landing gear recharging feet which when inactive will be in a position to capture the lower portion of the of the sides of the capture and retention hole. As the landing gear recharging feet and legs enter the capture and retention hole, the spring-loaded drone latch mechanism is pushed in and compresses the spring. Once the landing gear recharging feet are in close proximity to the recharging pad, the capture and retention hole sidewall catch portions are fully exposed and the compressed spring-loaded drone latch mechanism clicks into place, capturing and retaining the landing gear legs, thus preventing an accidental drone take-off or wind gust blowing the drone off the DDP or misaligning the drone on the DDP. Once two or more landing gear feet and legs are captured and retained, the drone is captured and retained upon the DDP. When captured and retained, the CT is closes and the drone batteries are recharged. When activated, the CT opens and the drone propellers start and the drone latch mechanism solenoid is electrically activated which pulls the spring-loaded latch mechanism away from the capture and retention hole sidewalls and releasing the drone legs from the latch mechanism, allowing drone take-off. The spring-loaded drone latch mechanism when inactive is in the catch position and ready to catch the capture retention sidewall portions upon return of the drone. The only time the drone latch mechanism solenoid is activated is during drone takeoff. The DDP in the third alternate embodiment can deploy the spring-loaded latch mechanism or the drone latch mechanism but not both simultaneously.

In a fourth alternate embodiment, the landing gear recharging feet include a docking camera in the center of the recharging feet and pointing downwards with a camera lens located within or near the center of a hole in a washer positioned at the bottom portion of the recharging feet which functions as a recharging contact. This docking camera or multiple cameras in multiple recharging feet are employed for precision landing maneuvers. One of the docking cameras is designated as the prime camera and other docking cameras are designated as secondary docking cameras. The docking camera video is processed through a docking processor module which comprises a combination processor defining a video processing unit and neural network having recognition and flight control capability. Upon landing, the drone returns to and hovers above the DDP location, the prime docking camera initially recognizes the orientation symbol on the docking plate, provides flight control signals to the drone for proper orientation, and secondarily recognizes the individual landing cone distinguishing marks and landing cone hole as do the secondary docking cameras. The processed video then provides the flight control and guidance necessary for precision landing and docking maneuvers for the landing gear and recharging feet to enter the landing cone hole and land on the docking pads. The processed video provides flight control and guidance necessary for precision landing and docking maneuvers for the landing gear and recharging feet to enter the landing cone hole and land on the docking pads and to shut of the drone propellers so as to complete the landing or docking. The docking cameras can further be employed to provide mission video from directly below the drone, as the docking cameras are fixed position cameras and will only provide video from a straight downward perspective.

In a fifth alternate embodiment, a landing gear shroud surrounds the landing gear legs and comprises four side plates and a bottom plate, affixed to the landing gear legs, to comprise the landing gear assembly. The landing gear assembly is affixed or attached to a drone. Affixed to each exterior side of the landing gear shroud are multicolor LED lights displaying a high illumination—green, yellow, red and/or white lights which are suitable for traffic signals and a white light to assist emergency personnel with overhead illumination. When two opposing landing gear shrouds display a green or yellow signal light to a first direction of traffic, two 90 degree adjacent landing gear shrouds display a red signal light for a second direction of traffic. The signal lights are controlled by a docking processor module and the docking processor module communicates with the central monitoring center and/or emergency personnel located at the scene via remote control units, so that emergency personnel or police can control the traffic signal lights and traffic flow around an incident or accident.

In a sixth alternate embodiment, the landing gear shroud also contains a shroud camera on each side of the shroud enabling observers to view a direction of traffic and assist in the control of traffic flow around an incident. The shroud camera video communicates with and is processed through the docking processor module.

In a seventh alternate embodiment, the landing gear shroud includes a bottom plate containing high illumination white LED lights so as to assist emergency personnel by providing overhead illumination.

In an eighth alternate embodiment, multiple drones from multiple DDP's or from emergency vehicles coordinate to work synchronously or as a swarm of drones at the scene of an incident to control traffic flow and aid in traffic incident forensics and to replace other drones when other drones are required to recharge their batteries.

In a ninth alternate embodiment, the FAA is advised prior to drone flight through a third-party application (app) to a Low Altitude Authorization and Notification Capability (LAANC) for flight and airspace approval, specifically for flights in Class B, C, D and some Class E airspace around airports. LAANC is powered by a small group of third party dedicated application providers that act as the medium between flight planning and approvals from the appropriate Air Traffic Control. The DDP initially advises the central monitoring center and/or submits a cell phone app for LAANC approval, often within seconds to minutes, and once approved the DDP begins drone deployment procedures. If the point of deployment is within Class G airspace, no LAANC approval is required.

In a tenth alternate embodiment, the DDP and DDP docking plate may support multiple (2, 3 or 4) small format drones, each with their own wired charging pads or wireless charging pad. Each drone may be deployed and operate independently, deployed in rapid succession and operate independently, and/or deployed in rapid succession and operate synchronously or as a swarm of drones.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a sectional side view of a DDP in a closed or UP position;

FIG. 2 is a sectional side view of a DDP in a closed or UP position with landing cones and recharging pads according to an embodiment

FIG. 3A is a top view of a docking plate showing landing cones and distinguishing marks;

FIG. 3B is a sectional side view of a docking plate and support slate assembly;

FIG. 4A is a sectional side view of a landing gear leg and docking latch with the docking latch in an inactive position;

FIG. 4B is a sectional side view of a landing gear leg and docking latch with the docking latch in an activated position;

FIG. 5 is a sectional side view of a docked drone;

FIG. 6 is a sectional side view of a DDP in an Open or Down;

FIG. 7 is a sectional side view of a DDP in a Closed or UP position with solar panels mounted on the top portion of the CT sections;

FIG. 8 is a front view of a drone attached to a light shroud assembly;

FIG. 9A is a top view of a light shroud attached to landing gear legs;

FIG. 9B is a front view of a light shroud attached to landing gear legs;

FIG. 10 is a block logic diagram of a drone docking processor module;

FIG. 11 is a block logic diagram of a DDP-CM; and

FIG. 12 is a remote control unit.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

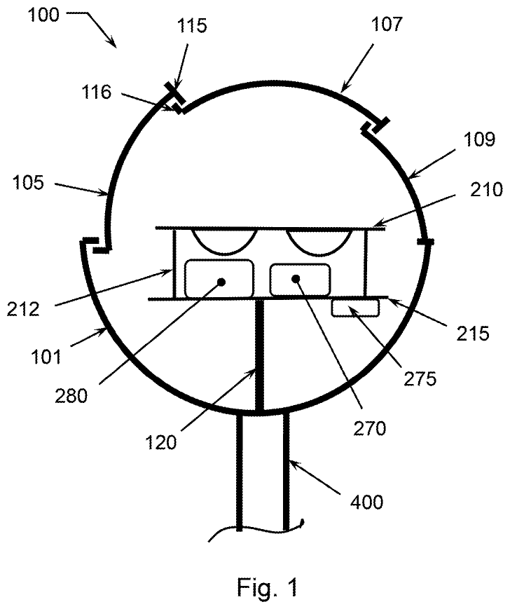

Referring to FIGS. 1-12, DDP 100 includes DDP enclosure base 101, CT sections 105, 107 and 109, docking plate 210 having recharging pads 217, support plate 215 attached to docking plate 210 by support rods 212. Support plate 215 is affixed to DDP enclosure base 101 by DDP support pillar 120 or like suitable mechanism that firmly holds docking plate 210 and support plate 215 in place. DDP 100 contains CM 270 and DDP batteries 275 located within DDP 100 and mounted on support plate 215. DDP 100 contains and encloses the inactive drone 300 where it resides or is stored until activation. CM 270 controls all aspects of DDP 100 to include opening and closing of CT sections 105, 107 and 109, recharging of DDP batteries 275 and drone batteries, as well as other optional equipment such as solar panels 106, 108 & 110, air conditioning unit 280, and weather station 280. In an inactive mode, DDP 100 contains drone 300 with CT sections 105, 107 and 109 in the UP or Closed position and enclosing drone 300 from the outside environment. While in the inactive mode, drone 300 makes electrical contact with recharging pads 217 allowing the drone batteries to recharge. Upon activation, CT sections 105, 107 and 109 open to fully expose drone 300, drone 300's motors start allowing the drone 300 to takeoff and performs its mission. Upon drone 300 return, drone 300 autonomously positions itself above DDP 100 for landing, verifies proper orientation using distinguishing marks 227 and 228 on docking plate 210, and then descends to docking plate 210 where drone 300 initially makes contact with docking plate 210, slides into a captured position or lands and makes contact with recharging pads 217. Upon drone 300 landing and being secure, the CT sections 105, 107 and 109 close to cover drone 300 and enclose it from the outside environment and DDP 100 reverts to an inactive mode where drone 300 remains until the next drone 300 activation after drone batteries are fully recharged.

Referring to FIGS. 1-12, DDP 100 includes DDP enclosure base 101, CT sections 105, 107 and 109, docking plate 210 having a plurality of landing cones 220 with each landing cone 220 having a landing gear hole 221 at the bottom thereof and sufficiently sized to allow drone landing gear leg 330 and feet 331 to enter hole 221 and be captured by a plurality of landing gear latches 333 located within landing gear leg 330 or a plurality of latches located in close proximity to the underside of the docking plate 210 and landing gear hole 221. Landing gear cones 220 further include distinguishing marks or rings 225 to individually distinguish select cones by docking cameras 337 located in a plurality of landing gear feet 331 to aid in precise drone docking maneuvers. Select landing gear feet 331 comprise a conductive material (e.g. metal) located at the bottom of landing gear feet 331 and make contact with and are supported by a plurality of recharging pads 217 so that the drone's batteries will be recharged while the done is stored within DDP 100. Recharging pads 217 are further supported by support plate 215 and separated from support plate 215 by insulation pads 218. Support plate 215 is attached to docking plate 210 by support rods 212. Support plate 215 is affixed to DDP enclosure base 101 by DDP support pillar 120 or like suitable mechanism that firmly holds the docking plate 210 and support plate 215 in place. DDP 100 contains CM 270 located within the DDP 100 on the underneath side of support plate 215. CM 270 controls all aspects of DDP 100 to include opening and closing of CT sections 105, 107 and 109, activating landing gear latch 333, recharging DDP batteries 275 and drone batteries. In an inactive mode, DDP 100 contains drone 300 with CT sections 105, 107 and 109 in the UP or Closed position and enclosing drone 300 from the outside environment. While in the inactive mode, drone landing gear feet 331 make electrical contact with recharging pads 217 allowing drone batteries to recharge. Upon activation, CT sections 105, 107 and 109 opens to fully exposing drone 300, drone 300 motors start and landing gear latch 333 activates to allow drone 300 takeoff. Once drone 300 takeoff is complete, landing gear latch 333 deactivates and awaits drone return. Upon drone 300 return, drone 300 autonomously positions itself above DDP 100 for landing, verifies proper orientation with using distinguishing marks 227 and 228 on docking plate 210 and distinguishing rings 223, 224 and 225 on the landing gear cones 220, then descends to the docking plate 210 where drones landing gear feet 331 make contact with plurality of landing cones 220 and in-turn landing cones 220 guide the drone landing gear feet 331 into the landing gear holes 221 at the bottom of landing cones 220, where landing gear legs 330 and feet 331 drop into hole 220 with the landing gear feet 331 making contact with the recharging pads 217 and the landing gear legs 330 being latched by the landing gear latch 333 located within the drone landing gear legs 330 or on an underside of docking plate 210. Once secure, CT sections 105, 107 and 109 close to cover drone 300 and enclose it from the outside environment and DDP 100 reverts to an inactive mode where drone 300 remains until the next drone 300 activation after drone batteries are fully recharged.

FIG. 1 shows the side sectional view of DDP 100 comprising spherical container comprising DDP enclosure base 101 and CT sections 105, 107 and 109 that can be mounted on the top of support pole 400. The CT comprises a plurality of CT sections 105, 107 and 109 and each CT section is shaped to form approximately one sixth to one eighth of a sphere and has leading edge 115 and trailing edge 116. CT sections 105, 107 and 109 may be rotated by a CT motor into a fully closed position as seen in FIG. 1, or rotated into an open position with CT sections 105, 107 and 109 rotated into enclosure base 101, exposing the entire upper half DDP 100 and drone 300 to the outside environment. As CT sections 105, 107 and 109 transition from an open position to a closed position, the leading CT section 109 is rotated first and as trailing edge 116 comes in contact with the second CT section's 107 leading edge 115 separated by a weatherproof barrier and the second CT section 107 will be rotated. When the second CT section's 107 trailing edge 116 comes in contact with the third CT section's 105 leading edge 115 the third section will be rotated until CT sections 105, 107 and 109 are fully rotated and completely closed. DDP 100 interior consists of a docking plate 210 that assists drone 300 landing or docking, support plate 215 with CM 270, DDP batteries 275, and DDP air conditioning unit 280, support rods 212 affixing docking plate 210 and support plate 215 as an assembly, a support pillar 120 that contains the docking plate 210 and support plate 215 assembly in place within DDC 100.

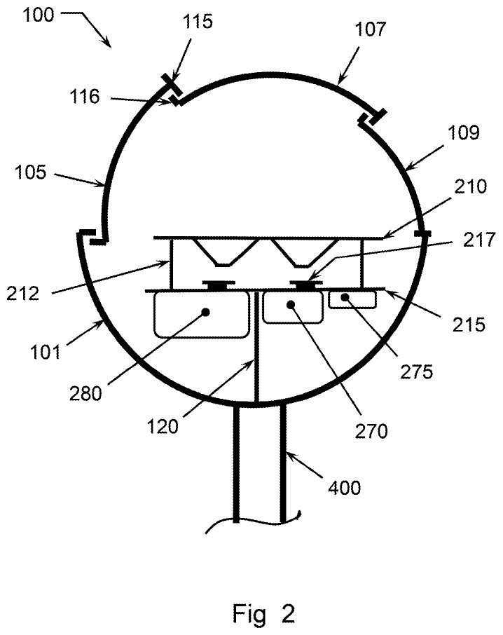

Referring to FIG. 2, DDP 100 includes DDP enclosure base 101, CT sections 105, 107 & 109, docking plate 210 which comprises a plurality of landing cones 220 with each landing cone 220 having landing gear hole 221 at the bottom thereof and sufficiently sized so as to allow drone landing gear leg 330 and feet 331 to enter hole 221 and be captured by one or more landing gear latches 333 located within the landing gear leg 330. Select landing gear feet 331 comprise a conductive material (e.g. metal) located at the bottom of landing gear feet 331 and make contact with and are supported by two recharging pads 217 so that drone 300's batteries will be recharged while done 300 is stored within DDP 100. Recharging pads 217 are further supported by support plate 215 and separated from support plate 215 by insulation pads 218. Support plate 215 is attached to docking plate 210 by support rods 212. Support plate 215 is affixed to DDP enclosure base 101 by a DDP support pillar 120 or like suitable mechanism that firmly holds docking plate 210 and support plate 215 in place. DDP 100 contains CM 270 located within DDP enclosure base 101 on the underneath side of the support plate 215. CM 270 controls all aspects of the DDP 100 including opening and closing of CT sections 105, 107 and 109, activating landing gear latch 333, recharging DDP batteries 275 and drone 300 batteries. In an inactive mode, the DDP 100 contains drone 300 with CT sections 105, 107 and 109 in the UP or Closed position and enclosing drone 300 from the outside environment. While in the inactive mode, drone 300 landing gear feet 331 make electrical contact with the recharging pads 217 allowing drone 300 batteries to recharge. Upon activation, CT sections 105, 107 and 109 open to fully exposing drone 300, drone 300 motors start and landing gear latch 333 activates to allow drone 300 takeoff. Upon completion of drone 300 takeoff, the landing gear latch 333 deactivates and awaits drone 300 return. Upon drone 300 return, drone 300 autonomously positions itself above DDP 100 for landing, verifies proper orientation with using distinguishing marks 227 and 228 and distinguishing rings 223, 224 and 225 on landing gear cones 220, then descends to docking plate 210 where the drone landing gear feet 331 make contact with plurality of landing cones 220 and in turn landing cones 220 guide drone landing gear feet 331 into landing gear holes 221 at the bottom thereof where the landing gear legs 330 and feet 331 drop into landing gear hole 221 with landing gear feet 331 making contact with recharging pads 217 and landing gear legs 330 being latched by the landing gear latch 333 located within drone landing gear legs 330 or on an underside of docking plate 210. Once secure, the CT sections 105, 107 and 109 close so as to cover drone 300 and enclose it from the outside environment and DDP 100 reverts to an inactive mode where drone 300 remains until the next drone 300 activation after drone batteries are fully recharged.

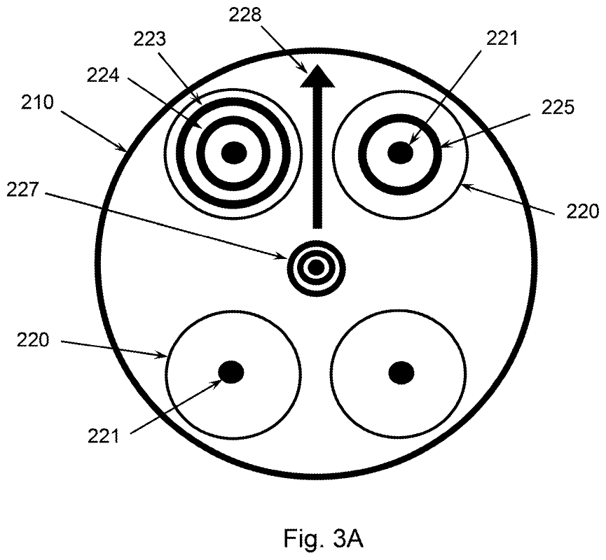

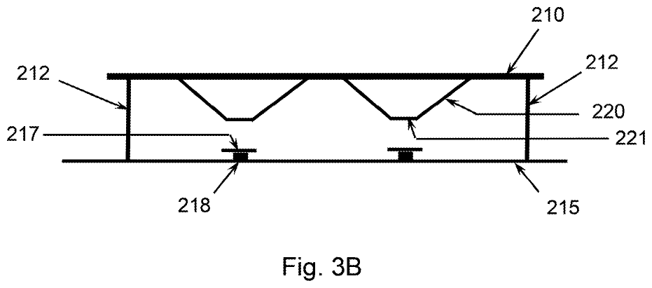

FIG. 3A shows the top view of docking plate 210, landing cones 220 and landing gear holes 221 at the bottom portion of the landing cones 220. Docking plate 210 further displays distinguishing marks 227 and 228 for drone 300 landing orientation and selecting of landing cones with distinguishing rings 223, 224 and 225 on landing cones 220 to aid in precise drone 300 landing maneuvers for precision docking. Landing gear feet cameras 334 forward video data to the docking processor module 375 comprising a video processing unit and neural network. The video processing unit and neural network recognize and identify distinguishing marks 227 and 228 and provided drone flight control signals to properly maneuver the drone for docking. Once drone 300 is properly oriented for docking, video processing unit and neural network recognize and identify distinguishing rings 223, 224 and 225 and landing gear hole 221 and provide drone flight control signals to properly maneuver the drone 300 landing gear feet 331 to enter the landing cone holes 221 and to dock drone 300 in a precise manner.

FIG. 3B shows the side sectional view of docking plate 210 and support plate 215 to include support rods 212, landing cones 220, landing gear holes 221, recharging pad 217 and recharging pad insulator 218. Upon landing, landing gear feet 331 make electrical contact with recharging pads 217, initiating drone 300 battery recharging. Landing gear latch 336 or docking plate latch first compresses, allowing the drone 300 to land, then springs into place latching landing gear leg 330 into place. When two or more landing gear legs 330 are latched the drone 300 is in the captured position.

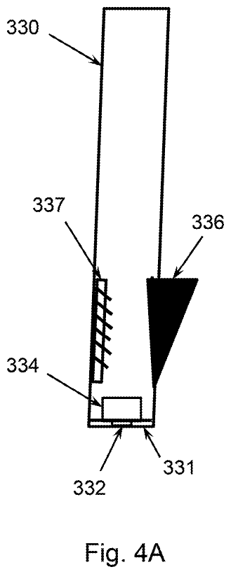

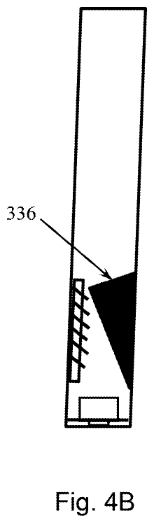

FIG. 4A shows a side sectional view of landing gear legs 330 to including landing gear foot 331, center hole 332, docking camera 334, landing gear latch 336 and landing gear actuator 337 in the inactive or deactivated position. Docking camera 334 is in a fixed position with the lens pointing straight downward and through Landing gear foot 331 center hole 332, so as to observe and identify distinguishing marks 227 and 228, distinguishing rings 223, 224 and 225, and landing cone hole 221 to aid in precision docking.

FIG. 4B shows a side sectional view of landing gear legs 330 including landing gear latch 336 and landing gear actuator 337 in the activated position. When in the activated position, landing gear latch 336 is actuated and disengages landing gear leg 330 from landing gear hole 221 and allows drone 300 takeoff.

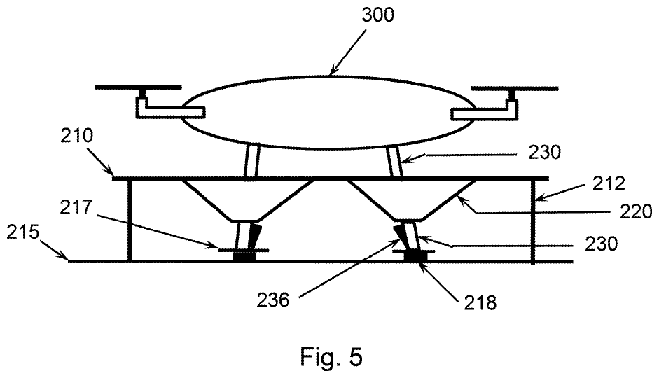

FIG. 5 shows a side sectional view of docked drone 300, docking plate 210, support plate 215, support rods 212 including landing cones 220, recharging pads 217, recharging pad insulators 218, with docked drone 300, landing gear legs 330 and landing gear latch 336 in an inactive or deactivated or captured state.

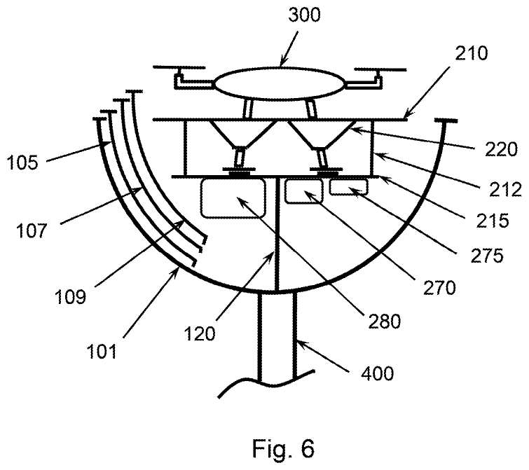

FIG. 6 shows a sectional side view of DDP 100 residing on support pole top 400 and CT sections 105, 107 and 109 in the down or open position with all CT sections 105, 107 & 109 stored within DDP enclosure base 101, fully exposing the docked drone 300 to the environment. The interior of the DDP 100 includes DDP support pillar 120 supporting docking plate 210, support rods 212, support plate 215, CM 270, DDP battery pack 275, and air conditioning unit 280, with docked drone 300 ready for takeoff or recently landed.

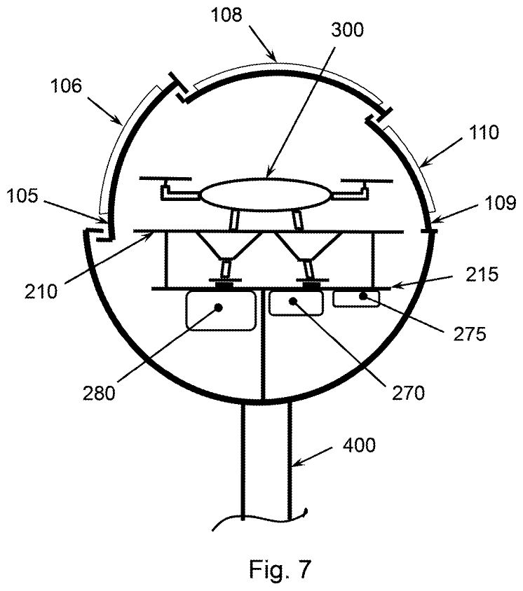

FIG. 7 shows a sectional side view of DDP 100 residing on support pole top 400 and CT sections 105, 107 and 109 in the up or closed position with all CT sections 105, 107, & 109 rotated to completely enclose docked drone 300 and protect it from the outside environment. Shown are the optional solar panels 106, 108 and 110 located on each of the CT sections 105, 106 and 108 respectively. The solar panels 106, 108 and 110 provide sufficient power to all internal DDP 100 devices to include CM 270, CT motor, DDP battery pack 275 recharger, and docked drone 300 battery recharger. For locations where CT mounted solar panels 106, 108 and 110 will not have sufficient power to support the DDP 100 devices, secondary pole mounted solar panels may be employed for off-the-grid systems. Also shown are the docking plate 210, support plate 215, CM 270, DDP battery pack 275 and air conditioning unit 280.

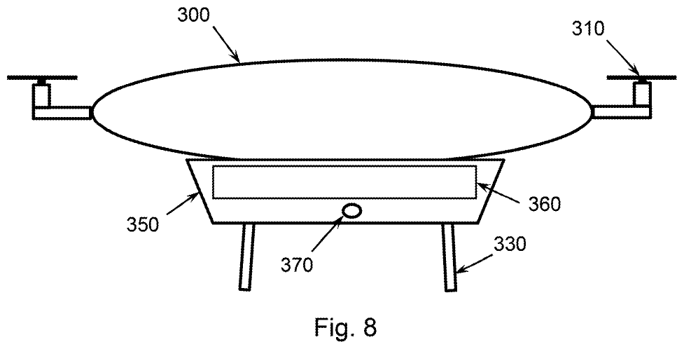

FIG. 8 shows a side view of Drone 300 with propellers 310 and landing gear assembly 350. The landing gear assembly 350 includes landing gear shroud, landing gear legs 330, multicolor LED (light emitting diode) traffic signal light 360 and shroud camera 370.

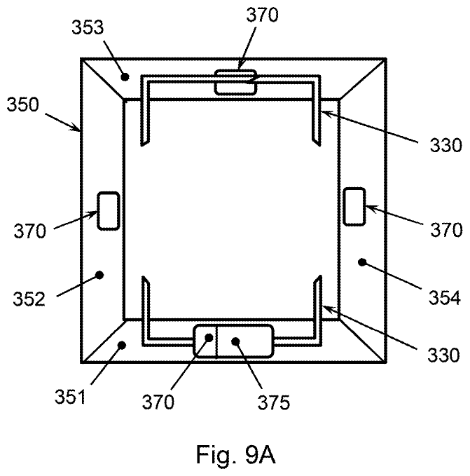

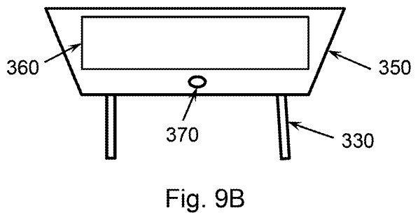

FIG. 9A shows a top view of landing gear assembly 350 interior including landing gear shroud side plates 351, 352, 353 and 354, landing gear legs 330, shroud cameras 370 on each of landing shroud side plates 351, 352, 353 and 354, and docking processor module 375. Landing gear assembly 350 surrounds landing gear legs 330 and consists of four side plates 351, 352, 353 and 354, a bottom plate (not shown), and docking processor module 375 affixed to the landing gear legs 330 to make up landing gear assembly 350. Landing gear assembly 350 is affixed or attached to a drone 300. Landing gear shroud sides 351, 352, 353 and 354 also contain shroud camera 370 on each of landing gear shroud sides 351, 352, 353 and 354 to enable observers to view a direction of traffic and assist in the control of traffic flow around an incident. The shroud camera video output stream communicates with and is processed through docking processor module 375.

FIG. 9B shows a side view of a landing gear assembly 350 exterior including affixed multicolor LED lights 360 displaying a high illumination green, yellow, red and/or white light color on each landing gear shroud side 351, 352, 353 and 354, suitable for traffic signals and white light so as to assist emergency personnel with overhead illumination. When two opposing landing gear shroud sides display a green or yellow signal light to a direction of traffic, the two 90 degree opposing sides display a red signal light for the opposing direction of traffic. Multicolor LED lights 360 are controlled by docking processor module 375 and docking processor module 375 communicates with the central monitoring center and/or emergency personnel located at the scene via remote control units or cell phone apps, so that emergency personnel or police can control multicolor LED lights 360 and traffic flow around an incident or accident. Docking processor module 375 includes a signal light controller and also communicates directly with autonomous or semiautonomous vehicles for a signal light status or change.

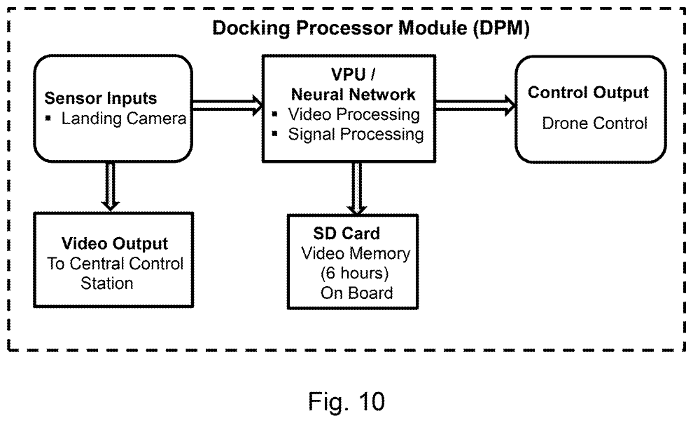

FIG. 10 shows a block diagram of a docking processor module 375. Docking processor module 375 comprises a video processing unit and a neural network with appropriate input and output capability. The video processing unit provides feature extraction and other video or signal processing techniques and outputs this data to a neural network. The neural network uses the video processing unit data and/or has the ability to input and process raw video data, and provide flight control parameters as an output. Inputs to the docking processor module 375 consist of video from the docking cameras 334, and from communication links from the central monitoring center. Outputs from the docking processor module 375 include flight control instructions for precise maneuvering and landing, video output communication links to central monitoring center and emergency personnel, autonomous vehicles and video storage SD card. The vision processing unit and neural network use deep learning and/or fast learning techniques and algorithms to detect and recognize distinguishing markings on the docking plate 210 and to determine drone 300 orientation, location and corrective action required to successfully and autonomously land or dock drone 300.

The vision processing unit and/or neural network Chip as manufactured by INTEL, NVIDIA, QUALCOM, GENERAL VISION and others may be used for processing. INTEL has a several vision processing unit chips, including one that features a neural compute engine with 16 core processors each providing the ability to perform separate pipeline algorithms, sensor fusion and/or convolution neural networks all in a low power chip suitable for battery operation. The neural compute engine portion adds hardware accelerators designed to dramatically increase performance of deep neural networks without including the low power characteristics of the chip. Known software and algorithms will be applied to this chip or others to detect, recognize and analyze vehicles, vehicular incidence and/or accidents, vehicles in a traffic lane, as well as drone 300 position and orientation to provide flight controls to precisely dock a drone 300. INTEL and GENERAL VISION both have low power chips that perform RBF (Radial Basis Function) neural networks in real time and can be considered fast learning (as opposed to deep learning) processors. GENERAL VISIONS's chips have 576 neurons with low power characteristics in a very small package, where each neuron consists of a processor and memory. Neurons can be configured in parallel or hierarchical and suitable for fast or real time learning and provides real time image or signal detection, classification and recognition. These processors (chips) are taught and not necessarily programmed, so programming is simplified and known by technologists in that field. Furthermore, GENERAL VISION's NEUROMEM Technology can be implemented in Field Programmable Gate Array (FPGA) chips and has been previously implemented on an INTEL chip and vision sensor die from OMNIVISION as a single chip camera solution.

Sensor data that is processed on neural network architectures, designed specifically around the Radial Basis Function (RBF) or K Nearest Neighbor modes of operation, can be considered an expert system, which recognizes and classifies objects or situations and makes instantaneous decisions, based on accumulated knowledge. It accumulates its knowledge ‘by example’ from data samples and corresponding categories. Its generalization capability allows it to react correctly to objects or situations that were not part of the learning examples. The learning capability of an RBF neural network model is not limited in time, as opposed to some other models. It is capable of additional learning while performing classification tasks. The RBF mode of operation allows for instant “learning on the fly”. As an example, tracking a vehicle, an operator can select an object to be tracked by placing a region of interest (ROI) around the object and selecting this region with a mouse click while neural network is in its learning mode, feature extraction algorithms may be applied (neural network can work with raw data or feature extracted data), data from the ROI will be loaded into the memory block automatically and sequentially (requiring from one to a multitude of neurons), thus training neural network from a single frame of imagery and in real time. Once learned, neural network will input the second frame of imagery, compare data from the entire frame with the neuron memory contents, find a match, classify the match, and provide an X-Y (coordinates) position or location output. This X-Y output will allow an associated pan and tilt mechanism to track the object of interest in real time. This process continues for each successive frame. In the event the vehicle turns or changes shape in relation to the camera location, the degraded quality of the neuron memory comparison will trigger the neural network learning mode to capture this changed data and commit more neurons for the new object shape. This neural network will simultaneously and continuously track the object, allowing itself the ability to track even as new patterns are learned.

Artificial Intelligence (AI) solutions today typically require high performance computers and/or parallel processors running AI or neural network software performing “Deep Learning” on back propagation and other neural networks. These systems can be large, consume significant power and be very costly for both the hardware and software. The learning phase for Deep Learning neural networks is generally performed in data centers or the “Cloud” and takes huge computing resources that can take days to process depending on the data set and number of levels in the network. After the network has been generated it can be downloaded to relatively low power processing systems (Target Systems) in the field. However, these target systems are typically not capable of embedded learning, and generally consist of powerful PCs and GPU (Graphic Processing Unit) acceleration resulting in significant cost and power consumption. Additionally, as the training dataset grows during the learning phase, there is no guarantee that the target hardware will remain sufficient and users may have to upgrade their target systems to execute properly after a new network has been generated during the learning phase. The major limitation to this approach is that new training data cannot be incorporated directly and immediately in the executable knowledge. It often also requires a fair amount of hand coding and tuning to deliver useful performance on the target hardware and is therefore not easily portable. Unlike Deep Learning networks, the neural network based on RBF networks can be easily mapped on hardware because the structure of the network does not change with the learned data. This ability to map the complete network on specialized hardware allows RBF networks to reach unbeatable performances in terms of speed and power dissipation both for learning and recognition. Preferably, the neural network has a NeuroMem™ architecture.

For traffic flow determination, low and constant latency is a very desirable feature as it guarantees high and predictable results. With Deep Learning, latency varies. Typically, the more the system learns, the slower it becomes. This is due to the Von Neumann architecture bottlenecks found in all computers which run sequential programs. Even the most modern multi-core architectures, even the best GPU or VPU architectures have limitations to their parallelism because some resources (cache, external memory access, bus access, etc.) are shared between the cores and therefore limit their true parallelism. The NeuroMem™ architecture goes beyond the Von Neumann paradigm and, thanks to its in-memory processing and fully parallel nature does not slow down when the training dataset grows. In fact, any environment which needs on-the-job learning, fast and predictable latency, easy auditing of decisions is likely to be better served by RBF neural networks, rather than by Deep Learning neural networks.

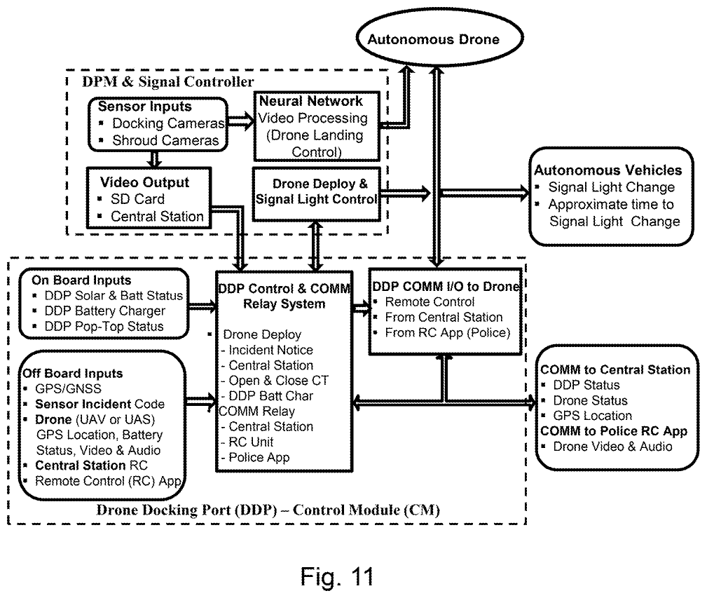

FIG. 11 shows a block logic diagram of DDP 100, CM 270 and docking processor module 375 and signal controller. The DDP 100 contains CM 270 that controls all aspects of the DDP 100 to include: CT opening and closing, DDP battery pack recharging, drone battery recharging and communications capabilities from other traffic sensor systems, central monitoring stations, first responder personnel and to act as a relay communications device to the drone in flight and/or other drones in flight in the near vicinity. CM 270 would relay video signals to the central monitoring center and provide for video recording at or in close proximity to the CM 270. CM 270 would also relay flight or camera control signals and audio commands from the central monitoring center to the drone 300 in flight, giving central monitoring center personnel the ability to override autonomous drone flight control should they desire. For example, CM 270 receives a traffic alert from a Traffic Flow Sensor System (TFSS) of a nearby traffic accident. The TFSS is a separate device and consists of an EO/IR camera, stereo camera pair, lidar and/or radar sensors and any combination thereof to detect and monitor traffic flow and abnormal traffic flow to include traffic incidence. Upon the TFSS issuing a traffic alert of an incident or accident, CM 270 initiates a signal to a central monitoring center, and the FAA for flight approval. Once approved, CM 270 signals DDP 100 to open CT and when open to start the drone propellers 310 and commence autonomous drone flight—to takeoff, fly to and hover over the accident, take photographs and videos of the scene and assist in accident scene forensics and to assist police in clearing the scene more rapidly, so as to resume normal traffic flow. Central monitoring center personnel have the ability to override the autonomous drone control at anytime to aid in the resolution and clearing of traffic incidence. Designated emergency personnel with first-hand knowledge of the incident would also have the ability to override the autonomous drone control at anytime to aid in the resolution and clearing of traffic incidence through their remote control devices or cell phone apps at the incident scene. Docking processor module 375 and signal light controller also communicates directly with autonomous or semiautonomous vehicles for a signal light status or change. The communication is selected from the group consisting of a Bluetooth communication, LoRa Communication, an internet communication, a cell phone network communication (4G/5G), an independent intranet network communication, an RF communication, a wired communication, or an optic fiber communication. Preferably, the data, video, audio and remote control commands are communicated or streamed in real time with very low latency in both directions—to and from the deployed drone 300, DDP 100 and central monitoring center. In the event of a malfunction, a malfunction signal or code will be sent to the central traffic control monitoring center for resolution.

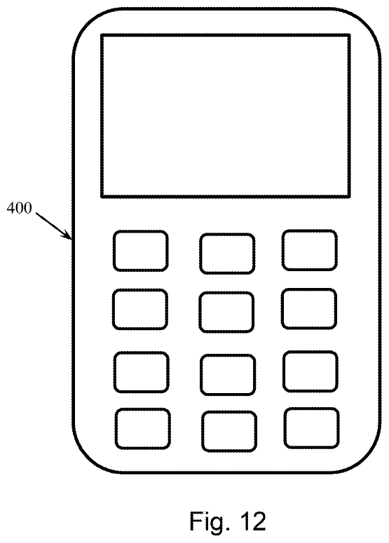

FIG. 12 shows a Remote Control Unit (RCU) 400 in another embodiment.

As explained above, various embodiments of the present invention use similar technology as implemented in consumer drones or cell phones with very small, lightweight, low power and low price (SWAP) components and powered by solar panels and rechargeable batteries. Coupled with LED's as traffic signals and overhead lighting, drone deployment from drone docking ports could substantially reduce the time and costs involved in resolving traffic incidents or accidents at the scene, direct traffic around the accident more efficiently, saving drivers time, fuel and cost and potentially save lives.

An advantage of the disclosed drone docking port is the ability to place (especially autonomous) drones in strategic locations along highways or traffic intersections conducive to rapid deployment to incidents, events and/or traffic accidents as first responders. These autonomous drones would reside in their drone docking ports until an incident arises, then be deployed, providing emergency and central monitoring center personnel live video of the scene with the ability to provide two way audio to injured or other persons, then to aid emergency personnel in directing vehicle traffic efficiently and safely around an incident and resolving the incident in a timely fashion.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A DDP comprising a housing having an inner cavity, an openable and closable top having a plurality of slidable members, a docking base, and a drone, wherein the docking base is affixed within the housing and the drone is deployable mounted on the docking base, and wherein the DDP is adapted such that when the top is in a closed position, the housing substantially seals out environment external to the DDP, and wherein when the top is in an open position, the drone is exposed so as to be able to launch.

2. The DDP of claim 1, wherein the drone includes at least one battery, and wherein when the drone is mounted on the docking base, the at least one battery is automatically charged by at least one of a wired battery charger and a wireless battery charger.

3. The DDP of claim 1, wherein the DDP is mounted on a top of a pole in near proximity to a target monitoring site.

4. The DDP of claim 1, wherein in response to a predetermined signal, the top automatically opens and the drone automatically flies to a target monitoring site.

5. The DDP of claim 4, wherein when the drone is at the target monitoring site, the drone performs at least one of the functions of recording video data of the target monitoring site, recording audio data of the target monitoring site, transmitting video data of the target monitoring site, transmitting audio data of the target monitoring site, transmitting audio data to the target monitoring site, directing traffic at the target monitoring site, providing a warning at the target monitoring site, illuminating the target monitoring site, and creating a light beacon over the target monitoring site.

6. The DDP of claim 1, wherein the docking base is adapted to receive drones of a plurality of shapes and sizes, and wherein the docking base is adapted to house a plurality of drones simultaneously, and wherein the docking base includes at least one target thereon and is adapted so as to automatically guide landing of a drone to the at least one target.

7. The DDP of claim 6, wherein the drone includes at least one landing foot and the docking base is adapted to receive the least one landing foot, and when the at least one foot is positioned on the at least one target, the at least one foot is automatically and releasably secured to the docking base.

8. The DDP of claim 7, when the securement of the at least one drone foot is adapted such that the drone will not dislodge in response to a predetermined wind load.

9. The DDP of claim 8, wherein the at least one foot includes a camera affixed thereto and positioned such that the foot affixed camera is adapted to perform at least one of record and transmit video at the target monitoring site and automatically guide the drone landing foot to the at least one target.

10. The DDP of claim 1, wherein each member of the plurality of slidable members have at least one seal mounted thereon and are adapted such that closure of the openable and closable top is achieved by sliding the members into a closed positioned such that a landed drone is enclosed therein and such that the seals seal the inner cavity from an external environment.

11. The DDP of claim 1, wherein the DDP functionally includes at least one of an electric motor, a back-up battery, a solar panel, an air conditioner, a heater, an anemometer, a temperature sensor, a relative humidity sensor, and a barometer.

12. A DDP comprising a housing having an inner cavity, an openable and closable top having a plurality of slidable members, a drone having a landing gear shroud, a docking base adapted to receive the a drone, and at least one battery, wherein the docking base is affixed within the housing and the drone is deployably mounted on the docking base, and wherein the DDP is adapted such that when the openable and closable top is in a closed position, the housing substantially seals out environment external to the DDP, and wherein when the openable and closable top is in an open position, the drone is exposed so as to be able to launch, and wherein when the drone is mounted on the docking base, the at least one battery is automatically charged by at least one of a wired battery charger and a wireless battery charger.

13. The DDP of claim 12, wherein the DDP is mounted on a top of a pole in near proximity to a target monitoring site, and wherein in response to a predetermined signal, the top automatically opens and the drone automatically flies to a target monitoring site.

14. The DDP of claim 13, wherein when the drone is at the target monitoring site, the drone performs at least one of the functions of recording video data of the target monitoring site, recording audio data of the target monitoring site, transmitting video data of the target monitoring site, transmitting audio data of the target monitoring site, transmitting audio data to the target monitoring site, directing traffic at the target monitoring site, providing a warning at the target monitoring site, illuminating the target monitoring site, and creating a light beacon over the target monitoring site.

15. The DDP of claim 12, wherein the docking base includes at least one target thereon and wherein the drone includes at least one landing foot, and wherein the DDP is adapted so as to automatically guide the drone landing foot to the at least one target, and wherein when the at least one foot is positioned on the at least one target, the at least one foot is automatically and releasably secured to the docking base such that drone will not dislodge in response to a predetermined wind load.

16. The DDP of claim 15, wherein the at least one foot includes a camera affixed thereto and positioned such that the foot affixed camera is adapted to perform at least one of record and transmit video at the target monitoring site and automatically guide the drone landing foot to the at least one target.

17. The DDP of claim 12, wherein each of the plurality of slidable members have at least one seal mounted thereon and are adapted such that closure of the openable and closable top is achieved by sliding the members into a closed positioned such that the seals seal the inner cavity from an external environment.

18. The DDP of claim 12, wherein the drone landing gear shroud comprises of a plurality of side panels and a bottom panel surrounding the landing gear and having a plurality of multicolor LED lights affixed thereto, wherein the multicolor LED lights include at least one of a green color, a yellow color, a red color and a white color, and wherein the LED lights are adapted to provide guidance to traffic at a target monitoring site, and wherein intensity of the multicolor LED lights is adapted to vary so as to be visible during daytime and nighttime from a distance of at least 800 feet therefrom, and wherein the white color LED light is adapted to illuminate a target monitoring site with overhead lighting during nighttime.

19. The DDP of claim 12, wherein the drone landing gear shroud comprises a plurality of cameras affixed to the side panels and the bottom panel, and wherein the cameras include a video processing unit and an artificial intelligence module adapted to process video data at a target monitoring site so as to aid in drone navigation and to detect at least one of a predetermined pattern and a predetermined object.

20. A DDP for use in providing a docking port for an unmanned aerial vehicle (drone) enabled to automatically perform takeoff, mission accomplishment, landing, and post-landing battery recharging, the DDP comprising an enclosure having a lower portion and an upper portion, a control module, a battery pack, and a battery charger, the enclosure lower portion forming at least one of a hemispherical shape, a semi-ovoidial shape, a cubic shape, a modification of a hemispherical shape, a modification of a semi-ovoidial shape, a modification of a cubic shape, and a combination thereof, and wherein the enclosure lower portion includes the control module, battery pack, and battery charger functionally mounted therein, the enclosure upper portion forming at least one of a hemispherical shape, a semi-ovoidial shape, a cubic shape, a modification of a hemispherical shape, a modification of a semi-ovoidial shape, a modification of a cubic shape, and a combination thereof, the enclosure upper portion further comprising a convertible enclosure upper portion having plurality of enclosure upper portion members, each enclosure upper portion member having a leading edge and a trailing edge, each leading edge having a “T” shaped member protruding at substantially 90 degrees therefrom, and each trailing edge having a weather strip affixed thereto, and wherein the enclosure includes at least one motor connected thereto, and wherein the DDP is adapted such that when the motor actuates to move the convertible enclosure upper portion from an open position to a closed position, the motor causes a first enclosure upper portion member to rotate and the rotational movement of the first enclosure upper portion member causes each subsequent enclosure upper portion member to follow until the enclosure upper portion is closed with the weather strips being in a compressed weather sealing state and a DDP inner cavity being formed thereby and being substantially sealed from an external weather environment, and wherein the DDP is adapted such that when the motor actuates to move the convertible enclosure upper portion from a closed position to an open position, the motor causes a first enclosure upper portion member to rotate and the rotational movement of the first enclosure upper portion member causes each subsequent enclosure upper portion member to follow until the enclosure upper portion is opened with the weather strips being in an compressed non-weather sealing state and the DDP being in a drone receivable and drone launchable state, and wherein opening the enclosure upper portion from a closed state occurs within 10 seconds, and wherein closing the enclosure upper portion from an open state occurs within 10 seconds, and wherein the DDP is adapted such that the enclosure upper portion is automatically positioned between a closed state and a fully opened state to a mid-state such that substantial weather protection is provided while also allowing the DDP inner cavity temperature to equalize with the DDP proximate external temperature, and wherein a degree of opening of such mid-state is automatically proportionate to the DDP proximate external temperature,

21. The DDP of claim 20, wherein the DDP includes a drone launchably and dockably retained therein.

22. The DDP of claim 20, wherein the DDP includes a drone docking plate mounted therein and having at least one charging pad thereon, the drone docking plate being adapted such that when drone contacts the at least one charging pad, at least one of wired charging and wireless charging of the drone is initiated.

23. The DDP of claim 22, wherein the drone docking plate comprises at least one of metal, plastic, fiberglass, and a combination thereof, and wherein the drone docking plate is formed in at least one of a circular shape, an oval shape, and a rectangular shape, and wherein the drone docking plate includes a plurality of charging pads, and wherein the drone docking plate automatically temporarily restrains a drone to the docking plate while a drone is charging from the docking plate.

24. The DDP of claim 20, wherein the DDP is mounted on an elevated elongate structure in near proximity to a target monitoring site.

25. The DDP of claim 21, wherein in response to a predetermined signal, the enclosure upper portion automatically opens and the drone automatically flies to a target monitoring site.

26. The DDP of claim 25, wherein when the drone is at the target monitoring site, the drone performs at least one of the functions of recording video data of the target monitoring site, recording audio data of the target monitoring site, transmitting video data of the target monitoring site to a central monitoring station, transmitting audio data of the target monitoring site to a central monitoring station, receiving audio data from a central monitoring center, receiving non-audio data from a central monitoring center, directing traffic at the target monitoring site, providing a warning at the target monitoring site, illuminating the target monitoring site, and creating a light beacon over the target monitoring site.

27. The DDP of claim 26, wherein the data from a central monitoring station comprises a drone override command.

28. The DDP of claim 20, wherein the battery pack is adapted to operate the DDP without external power or recharging for at least 36 hours, and wherein the battery pack is adapted to continuously recharge a drone battery for at least 2 hours.

29. The DDP of claim 20, wherein the DDP includes at least one of a solar panel adapted to recharge the battery pack, an air conditioning unit adapted to automatically control temperature and humidity inside of the DDP, a heating unit adapted to automatically control temperature and humidity inside of the DDP, a weather monitoring device adapted to monitor at least one of temperature, wind speed, humidity, rain, snow, ice, fog, and dust.
